(19) United States
(12) Patent Application Publication
(10) Pub. No.: US 2014/0330731 A1
(43) Pub. Date: Nov. 6, 2014

(54) SYSTEM AND METHOD FOR MANAGING BACKFLOW PREVENTION ASSEMBLY TEST DATA

(71) Applicant: RDH Environmental Services, LLC, Phoenix, AZ (US)

(72) Inventors: Randall Helfrich, Chandler, AZ (US); Ronald Lazaro, Dearborn, MI (US)

(73) Assignee: RDH Environmental Services, LLC, Phoenix, AZ (US)

(21) Appl. No.: 14/271,151

(22) Filed: May 6, 2014

Related U.S. Application Data
(60) Provisional application No. 61/820,048, filed on May 6, 2013.

(51) Int. Cl. G06Q 30/00

(52) U.S. Cl. CPC G06Q 30/018
USPC 705/317

(57) ABSTRACT

The present disclosure includes a system, method and computer program product for managing Backflow Prevention Assembly (“BPA”) test result data. A Compliance Management System (“CMS”) may generate a keycode indicating a necessary BPA teat which is sent to a purveyor. The purveyor may transmit the keycode to a BPA owner, and the BPA owner may transmit the keycode to a tester. The tester may enter the keycode into a Backflow Test Application (“BTA”) which identifies the BPA. The tester may test the BPA and enter test results into the BTA on a portable device. The BTA may transmit the test results to the CMS. CMS may integrate the test results into a to of BPA test results. A purveyor may approve the test results, and the CMS may generate a new keycode for the next annual test for the BPA.

### CROSS-REFERENCE TO RELATED APPLICATIONS

This application claims priority to U.S. Provisional Application Ser. No. 61/820,048, entitled “SYSTEM AND METHOD FOR MANAGING BACKFLOW PREVENTION ASSEMBLY TEST DATA,” and filed on May 6, 2013, the contents of which are incorporated by reference herein in its entirety.

### FIELD

The present disclosure generally relates to systems and methods for capturing and processing environmental compliance data, and more particularly to capturing and processing backflow prevention assembly test data to comply with regulations.

### BACKGROUND

Potable water delivery systems utilize many safeguards to maintain adequate water quality. One such safeguard is backflow prevention assemblies. Water is typically maintained under significant pressure in deliver systems in order to provide adequate water pressure at delivery points, such as buildings, and to prevent contaminated water from entering the system at delivery points. However, in certain instances, such as in the event of a water main break or extremely heavy water use, the water pressure at a delivery point may exceed that in the water delivery system and contaminated water may enter the delivery system. This is described as backflow.

In order to prevent occurrences of backflow, many regulatory agencies require backflow prevention assemblies (“BPA”) to be installed at certain locations. BPAs prevent water from entering the delivery system. Various methods of preventing backtilow exist, such as air gaps, double check valve assemblies, reduced pressure principal assemblies, and pressure vacuum breaker assemblies. In general, BPAs use valves to prevent contaminated water from reversing direction and entering the delivery system.

BPAs must be periodically tested to ensure proper backflow prevention. Regulatory agencies may specify how often the BPAs must be tested. In many jurisdictions, certified testers must test the BPAs annually. The tester must submit the test results to the local purveyor. In many cases, backflow testers record test results on paper, then send the results to the purveyor. This can lead to delays and errors in recording test results. Additionally, this creates substantial work on the purveyor side in order to assemble the data from various testers and tests.

### SUMMARY

The present disclosure includes a system, method and computer program product for managing Backflow Prevention Assembly (“BPA”) test result data. A Compliance Management System (“CMS”) may generate a keycode indicating a necessary BPA test which is sent to a purveyor. The purveyor may transmit the keycode to a BPA owner, and the BPA owner may transmit the keycode to a tester. The tester may enter the keycode into a Backflow Test Application (“BTA”) which identifies the BPA. The tester may test the BPA and enter test results into the BTA on a portable device. The BTA may transmit the test results to the CMS. CMS may integrate the test results into a log of BPA test results. A purveyor may approve the test results, and the CMS may generate a new keycode for the next annual test for the BPA.

A method may comprise receiving a keycode from an owner of a backflow prevention assembly. The keycode may be transmitted to a compliance management system. The method may comprise receiving information regarding the backflow prevention assembly in response to transmitting the keycode.

A method may comprise receiving a notification of an upcoming due date for a backflow prevention assembly. The method may comprise storing backflow test data. A location of a computer-based system may be determined. The backflow test data, the location of the computer-based system, and a timestamp may be transmitted to at least one of a purveyor or an owner of the backflow prevention assembly.

A method may comprise registering a purveyor. A notification of an upcoming test date for a backflow prevention assembly may be transmitted to an owner of the backflow prevention assembly. Backflow test data may be received for the backflow prevention assembly. The method may comprise receiving a location of a testing device, a timestamp of the backflow test data, and a tester signature. The backflow test data may be certified based on the location of the testing device, the timestamp, and the tester signature.

### BRIEF DESCRIPTION OF THE DRAWINGS

A more complete understanding may be derived by referring to the detailed description and claims when considered in connection with the Figures, wherein like reference numbers refer to similar elements throughout the Figures, and:

FIG. 1 illustrates a system for managing backflow prevention assembly test results according to various embodiments of the disclosure; and

FIG. 2 illustrates a process for recording test results according to various embodiments;

FIG. 3 illustrates a process for initiating a test using a keycode according to various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, a Compliance Management System (“CMS”) may present user interfaces which allow tracking and entry of Backflow Prevention Assembly (“BPA”) testing data. A tester may use an application on a mobile device to access and enter testing information. The tester may use the mobile device to transmit test results to the CMS, and the CMS may transmit test results to purveyors. A purveyor may be a municipal agency. Testers, purveyors, and BPA owners (owners may also be referred to as clients) may access a database which provides information regarding testing history for BPAs and future testing requirements.

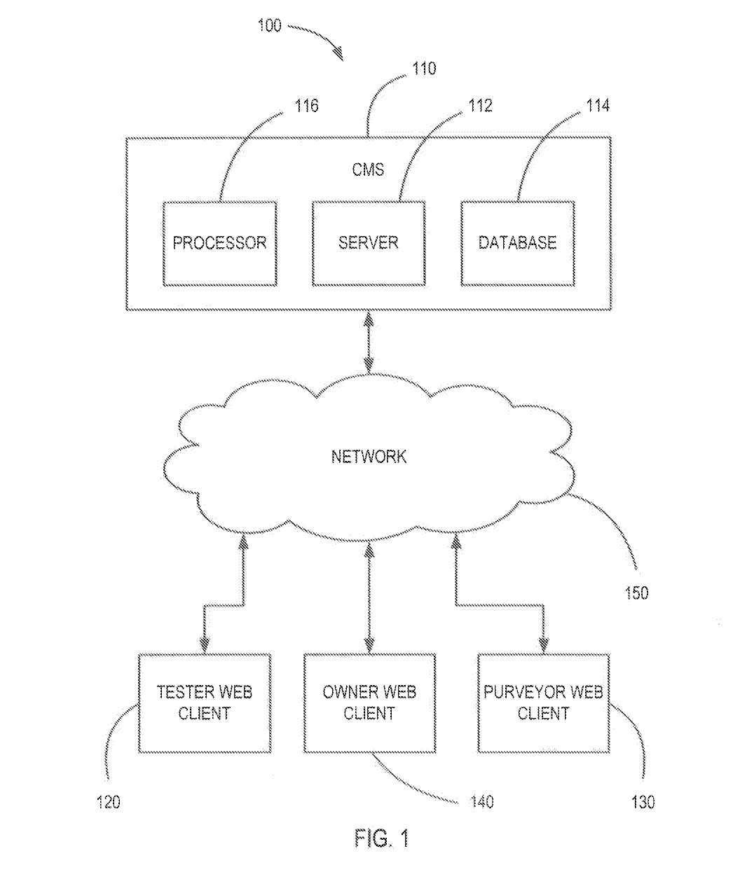

Referring to FIG. 1, in various embodiments, a system 100 for managing BPA test data may comprise CMS 110, tester web client 120, purveyor web client 130, and BPA owner web client 140. CMS 110 may further comprise server 112, database 114, and processor 116. The various system components may communicate via network 150.

CMS server 112 may comprise any single server or combination of servers capable of creating, displaying, transmitting, and/or processing BPA test data. CMS server 112 may communicate with CMS database 114 in order to retrieve stored information. CMS database 114 may comprise any database or combination of databases capable of storing information which may be accessed by CMS server 112. Web clients may be any device, such as a personal computer or portable device, which allows a user to communicate with CMS server 112.

In various embodiments, CMS 110 may allow purveyors, BPA testers, and BPA owners to interact to facilitate the testing of BPAs. A purveyor may subscribe for an account through a web application provided by CMS 110. The purveyor may import their BPAs, activate a BPA test date monitoring service, and let CMS 110 generate and distribute electronic notifications to all interested parties, such as BPA owners and BPA testers. CMS 110 may store data on CMS database 114, which may be accessed by registered users.

CMS 110 may alert registered users, such as purveyors, BPA testers, and BPA owners, of upcoming or past due BPA test dates. CMS 110 may generate codes, such as barcodes, which may be attached to BPAs to facilitate testing of the BPAs.

A BPA tester may receive a notification of an upcoming or past due BPA test date via tester web client 120. The BPA tester may conduct a test of the BPA at the physical location of the BPA. The tester may input backflow test data into tester web client 120, and tester web client 120 may transmit the data to CMS 110. CMS 110 may notify the BPA owner and the purveyor of the test results.

On various embodiments, tester web client 120 may comprise a geo-location module, such as a GPS. The geo-location module may store the location of the tester web client 120. Tester web client 120 may transmit the location of tester web client 120 and a location of the BPA along with the backflow test data. This may ensure that the tester was actually at the location of the BPA. Furthermore, tester web client 120 may attach a time stamp to the backflow test data, and the tester may be required to enter a signature into tester web client 120. The geo-location data, the timestamp, and the signature may certify that the backflow test data is complete. Tester web client 120 may transmit the backflow test data, geo-location data, timestamp, and signature to CMS 110.

In various embodiments, tester web client 120 may comprise a barcode reader. The barcode reader may be configured to read a barcode on a BPA. The barcode may identify the particular BPA and/or a particular test for the BPA. In various embodiments, the barcode may be generated by CMS 110. In various embodiments, tester web client 120 may be referred to as a testing device.

Tester web client 120 may provide a variety of functions to a tester. For example, a tester may register for an individual sir company annual subscription with CMS 110. A tester may authenticate by entering username and password into a secure login web page. A tester may select from options such as customers, municipal agencies, account details, backflow assemblies, backflow tests, and testers. Additional testers may be added to the account. A list of BPA owners and BPA owner contacts may be imported or manually entered. The tester may generate login credentials for a BPA owner. An invite may be sent to the BPA owner with the login credentials. A list of purveyors may be imported or manually entered. The tester may generate login credentials for a purveyor. The purveyor may be invited to login to the system using the login credentials. A list of BPAs may be added. The BPAs may be associated with the proper BPA owner and purveyor. The tester may enter BPA test results. The tester may view historic test results for each BPA. Tester web client 120 may generate test result reports and distribute the reports to purveyors and BPA owners. Tester web client 120 may receive notifications of imminent or past due test dates for BPAs. Tester web client 120 may allow a tester to start and finish BPA testing with or without internet connectivity. BPA testing may be started, saved, and resumed with or without internet connectivity. In various embodiments, various functions of tester web client 120 may be performed through a web application, and various functions may be performed through a mobile application.

Purveyor web client 130 may provide a variety of functions to a purveyor. A purveyor may register for a subscription to CMS 110. The purveyor may login to CMS 110 with as username and password. The purveyor may select from options such as tester details, backflow assemblies, backflow tests, and account details. The purveyor may view a list of approved BPA testers that service BPAs. The purveyor may register and maintain additional municipal agents that need access to the system. The purveyor may enter lists of BPA owners. The purveyor may invite BPA testers to register with CMS 110. The purveyor may associate BPAs with BPA owners. The purveyor may enter BPA test results and view historic test results for a BPA. The purveyor may view BPA tester details, such as company name, address, and contact information. The purveyor may view a list of BPAs in the purveyor's jurisdiction. The purveyor may view BPA details. The purveyor may view or print recent and historic test results for any BPA.

BPA owner web client 140 may provide a variety of functions to a BPA owner. A BPA owner may login to CMS 110 with a username and password. The BPA owner may select from options such as tester details, backflow assemblies, backflow tests, and account details. The BPA owner may view BPA tester details, such as company name, address, and contact information. The BPA owner may view a list of BPAs owned by the BPA owner. The BPA owner may view BPA details. The BPA owner may view or print recent and historic test results for any BPA. The BPA owner may invite BPA testers to register with CMS 110. The BPA owner may generate an assembly test notification and sent the notification to a BPA tester.

Web clients may include any device (e.g., personal computer) which communicates via any network, for example such as those discussed herein. Web clients may include browser applications comprising Internet browsing software installed within a computing unit or a system to conduct online transactions and/or communications. These computing units or systems may take the form of a computer or set of computers, although other types of computing units or systems may be used, including smart phones, laptops, notebooks, tablets, hand held computers, personal digital assistants, set-top boxes, workstations, computer-servers, main frame computers, mini-computers, PC servers, pervasive computers, network sets of computers, personal computers, such as iPads®, iMACs®, and MacBooks®, kiosks, terminals, televisions, or any other device capable of receiving data over a network. A web client may run Microsoft Internet Explorer®, Mozilla Firefox®, Google Chrome®, Apple Safari®, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client may include but is not limited to an operating system (e.g., Windows, OS2, UNIX, Linux, Solaris, MacOS, PalmOS, etc.) as well as various conventional support software and drivers typically associated with computers. A web client may include but is not limited to any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

Network 150 may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®, cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modern communication, cable modern, dish networks, ISDN, Digital Subscriber Line (DSL), or various wireless communication methods, see, e.g., GILBERT FIELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

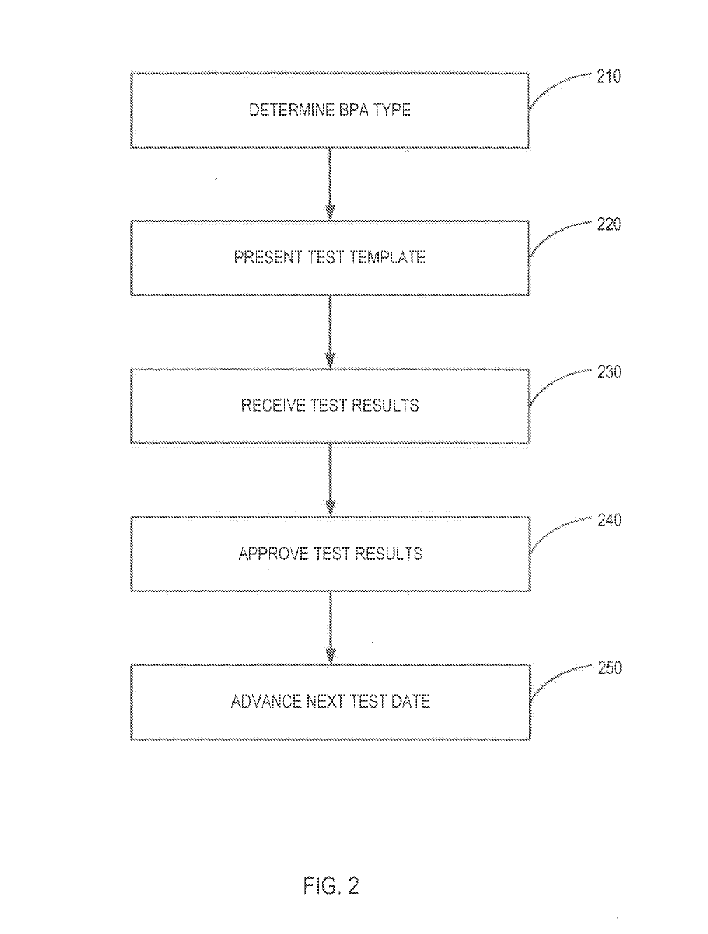

Referring to FIG. 2, a tester process is illustrated according to various embodiments. A tester may download a Backflow Test Application (“BTA”) onto a tester web client 120. In various embodiments, the tester web client 120 may comprise a mobile device, such as a smartphone or tablet. However, tester web client 120 may comprise any device capable of communicating via network 150. A tester may be required to login to a tester account via the BTA. In various embodiments, a tester may be required to pay in order to use the BTA. For example, the tester may be required to pay a fee for each test completed or submitted, or may be required to pay a subscription fee.

Once logged in, the tester may be presented with a variety of options. For example, to Subscription section may display the tester's account status and history of use and payments. A Profile section may display and allow the tester to modify their demographic and account information. A Tests section may display completed tests and allow the tester to send reports to company contacts.

The BTA may determine a type of BPA being tested. (Step 210). The BTA may present a test template which allows the tester to input BPA test results into the BTA. (Step 220). Test results may include information such as valve pressures, test date, repairs made, problems with the BPA, or any other information regarding the BPA. Depending on the type of BPA, different test result fields may be presented to the tester. For example, for a Reduced Pressure Principal Assembly, an RP Test may require the value of an opened Differential Pressure Relief Valve, whether Check Valve #2 closed tight or leaked, the actual value of Check Valve #1, and the date of test. For a Double Check Valve Assembly or a Double Check Detector Assembly, a DC Test may require a value of Check Valve #1 opening pressure, whether Check Valve #1 closed tight or leaked, the value of Check Valve #2 opening pressure, whether Check Valve #2 closed tight or leaked, and the date of test. For a Pressure Vacuum Breaker Assembly, a PVB test may require a value of Air Inlet Opening Pressure, whether the inlet opened, the value of Check Valve Holding Pressure, whether the Check Valve leaked, whether there was backpressure, and the date of test.

In response to the BPA passing the test, the tester may enter the date of test, an identification of the tester, whether the BPA is properly installed, and check a certification statement. In response to the BPA not passing the test, the BTA may provide the tester with a sequence for repairing the BPA, which may include cleaning, replacing the rubber kit, replacing a repair kit, or any other steps. The tester may describe the repairs, and the appropriate test may repopulate for the tester to test the BPA again.

In various embodiments, the BTA saves the test results, and the tester may print or email the test results to the purveyor, owner, or any other entity. CMS 110 may receive the test results from the tester web client 120. (Step 230). In various embodiments, in response to the tester inputting the test results, the BTA automatically transmits the results to CMS 110. In various embodiments, the results may be transmitted in a standardized format, such that CMS 110 may integrate the test results into previously stored data in database 114. In various embodiments, the test results may be quarantined for city approval of the BPA.

In various embodiments, the BTA may comprise a location of a BPA, for example a GPS location. The tester may use the GPS location in order to locate the BPA. In various embodiments, in response to the tester web client being located within a specified distance of a BPA, the BTA may automatically load information relevant to the particular BPA. Thus, when a tester arrives on location and opens the BTA, the test result template may be automatically provided for test result input. In various embodiments, the BTA may comprise a map application which displays the location of the BPA on a map, allowing the tester to locate the BPA.

In various embodiments, the BTA may store a location of the tester web client 120 at the time that the test result data is entered in the BTA. The BTA may also timestamp the data and request a tester signature. The BTA may transmit the location of the tester web client 120, the timestamp, and the tester signature to CMS 110 in order to certify the validity of the test result data.

In various embodiments, as BPA may comprise a machine readable code, such as a 2 dimensional bar code or a QR code. The machine readable code may comprise information specific to the BPA. The tester may scan the machine readable code with the tester web client 120, and the BTA may load information relevant to the BPA. In various embodiments, the tester web client 120 may detect the BPA using blear Field Communication (“NFC”) in order to load information relevant to the BPA.

In various embodiments, the tester may manually input test results into the test result template. However, in various embodiments, the BPA may transmit the test results directly to the tester web client 120. For example, the BPA may self-monitor pressures, etc., and may transmit the test results via NFC or may display a machine readable code comprising the test results on a display which may be read by the tester web client 120.

Once the test results have been input into the BTA, the BTA may transmit the test results to the purveyor via CMS 110. In various embodiments, the BTA may determine whether the purveyor has a Backflow Management Application (“BMA”). In response to detecting a BMA, the BTA may transmit the test results in a BMA standardized format, such that the test results may be integrated into the BMA. In response to not detecting a BMA, the BTA may transmit the test results to the purveyor. In various embodiments, the BTA transmits the test results in the same format regardless of whether the purveyor has as BMA. If the purveyor has a BMA, the BMA may identify the data and integrate the test results into the BMA. However, if the purveyor does not have a BMA, the purveyor may still view the test results and may need to manually enter the test results into a database.

The BMA may provide a variety of functions for purveyors. In various embodiments, the BMA may reside on the CMS server as a Software as a Service (“SAAS”), and purveyors may access the BMA via a web browser on purveyor web client 130. Purveyors may pay a subscription fee in order to have access to BMA. The BMA may comprise a log which stores past test results for BPAs in a purveyor's jurisdiction. A purveyor may search for BPAs using any criteria, such as location, owner, last test date, etc., and the BMA may display all information contained in the log pertaining to selected BPAs. For example, the BMA may display the test results for each time the BPA was tested, and any repairs performed or recommended to be performed.

The BMA may allow purveyors to modify data regarding existing BPAs. Additionally, purveyors may be able to view global lists of completed BPA tests arranged by date, location, or any other criteria. Additionally, purveyors may view lists of available testers and their associated credentials.

In various embodiments, the BMA may receive test results from a tester web client 120. The BMA may determine that the test results are in a standardized format, and the BMA may parse the test results into individual data components. The BMA may insert the data components into the log. Thus, in various embodiments, the test results may automatically populate in the BMA without intervention from the purveyor. The BMA may perform an initial review of the test results to determine whether all necessary fields contain data in the correct format. In response to determine that is required field is incomplete or incorrectly formatted, the BMA may transmit an error message to the tester requesting corrected test results.

The BMA may transmit a notification to the purveyor indicating that test results have been received. In various embodiments, the purveyor may need to manually input the test results into the BMA. The purveyor may approve or reject the test results as complying with regulations. (Step 240). in response to the purveyor approving the test results, the BMA may advance the next test date by a specified time period, such as a year. (Step 250). In response to the purveyor accepting or rejecting the test results, the BMA may transmit a message to the tester and/or the BPA owner indicating acceptance or rejection of the test results.

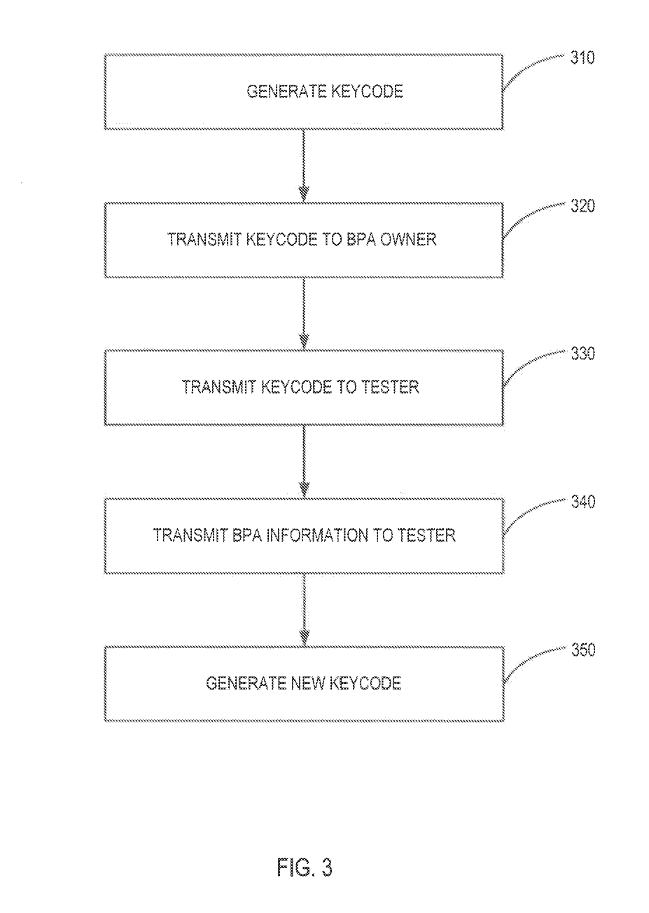

Referring to FIG. 3, a process for initiating a test using a keycode is illustrated according to various embodiments. In various embodiments, CMS 110 may generate a keycode. (Step 310). The keycode may comprise any combination of letters, numbers, or other characters or symbols. The keycode may correspond to a particular purveyor and/or BPA. In various embodiments, CMS 110 may automatically generate a keycode in response to a window opening up for testing a particular BPA. For example, regulations may require that a BPA be tested within 60 days of a particular date, and in response to a current date being within the 60 day time period, CMS 110 may generate a keycode for the BPA. In various embodiments, CMS 110 may generate the keycode a specified amount of time prior to the window in order to give a BPA owner a sufficient amount of time to arrange for testing of the BPA.

In various embodiments, CMS 110 transmits the keycode to a BPA owner. (Step 320). The BPA owner may be a city, state, utility, individual, or any other entity responsible for maintaining one or more BPAs. In various embodiments, the BPA owner may transmit the keycode to a tester. (Step 330). In various embodiments, the keycode may be transmitted to a plurality of testers, and a tester may choose to accept the keycode. A plurality of available active keycodes representing BPAs that require testing may be stored in a queue, and in response to a tester accepting a keycode, the keycode may be removed from the queue. The tester may enter the keycode into the BTA, and the BTA may transmit the keycode to CMS 110. CMS 110 may provide the tester with the necessary information regarding the BPA. (Step 340). For example, the information may comprise, the BPA location, BPA number, test window, and service history of the BPA. In various embodiments, the keycode may not be activated until the test window is open. Thus, the tester may not be able to obtain information using the keycode and/or may not be able to enter information regarding the BPA into CMS 110 until the window is activated. This may prevent a tester from either intentionally or accidentally testing the BPA outside the test window.

In various embodiments, the keycode may be valid for a limited time. For example, the keycode may be valid only during the testing window, or for one year, or until test results have been accepted for the BPA. In response to expiration of the limited time, the keycode may expire, and CMS 110 may generate a new keycode for the following year (Step 350). In various embodiments, the keycode may be valid for multiple tests of the same BPA throughout the year. Thus, if the BPA needs to be retested during the year due to a faulty test, repairs, or for any other reason, the tester may use the same keycode.

In various embodiments, the BTA comprises a repair module. The repair module may comprise a parts list for one or more BPA models. In various embodiments, the repair module may provide an exploded view of the BPA being tested. In various embodiments, the tester may select from any model of BPA. The tester may select desired parts or a kit of parts, and the tester may place an order or request a quote for the selected parts. The repair module may provide a list of vendors. In various embodiments, the tester may add a vendor to the list of vendors. The BTA may transmit an email or order form to the vendor. In various embodiments, the order is transmitted via CMS 110. The vendor may reply via CMS 110 to confirm an order.

In various embodiments, the BTA may comprise a billing module. The tester may use the billing module to invoice a BPA owner directly or send communications to third party accounting software for a billing entry. The tester may set default or import pricing for various goods or services, including items, groups of items, labor, trip charges, mileage, equipment, services, administrative, shipping, inspections, consulting, or an other goods or services. In various embodiments, in response to the tester placing a parts order from a vendor, the BTA or CMS 110 may automatically send the invoice to the BPA owner. The billing module may allow the tester to bill the BPA owner based on the particular BPA, and may display line items. CMS 110 may transmit an invoice to the BPA owner, and the BPA owner may login to CMS 110 in order to view all billings.

In various embodiments, the BTA may comprise a business reporting module. The business reporting module may allow the tester to see reports on costs, labor, assemblies, parts, work load, vendors, and any other reports which may use any data within the system to create a report.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website, a uniform resource locator (“URL”), a document (e.g., a Microsoft Word® document, a Microsoft Excel® document, an Adobe® .pdf document, etc.), an “ebook,” an “emagazine,” an application or microapplication (as described below), an SMS or other type of text message, an email, facebook, twitter, MMS and/or other type of communication technology. In various embodiments, a channel may be hosted or provided by a data partner. In various embodiments, the distribution channel and/or the may comprise at least one of a merchant website, a social media website, affiliate or partner websites, an external vendor, to mobile device communication, social media network and/or location based service. Distribution channels may include at least one of a merchant website, social media site, affiliate, or partner websites, an external vendor, and a mobile device communication. Examples of social media sites include Facebook®, foursquare®, Twitter®, MySpace®, LinkedIn®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

The present computer-based system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

The terms “computer program medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WE SERVER).

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system Which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands queries, files, data for storage, and the like in digital or any other form.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS 110 to further enhance security.

The computers discussed herein may provide a suitable website or other Internet-based graphical user interface which is accessible by users. In various embodiments, the Microsoft Internet information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, interbase, etc., may be used to provide an Active Data Object (ADO) compliant database management system. In various embodiments, the Apache web server is used in conjunction with a Linux operating system, a MySQI, database, and the Perl, PHP, and/or Python programming languages.

Any of the communications, inputs, storage, databases or displays discussed herein ma he facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous javascript And XML), helper applications, plug-ins, and the like. A server ma include a web service that receives a request from a web server, the request including a URL and an IP address. The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts, See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps, it should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code in C,” by Bruce Schneier, published b John Wiley & Sons (second edition, 1995); (2) “Java Cryptography” by Jonathan Knudson, published by O'Reilly Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software a stand alone system, a distributed system, a method, a data processing system, a device for data processing, and/or a computer program product. Accordingly, any portion of the system or a module may take the form of a processing apparatus executing code, an interne based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the Hock diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The terra “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. Reference to an element in the singular is not intended to mean one and only one unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on as tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A computer-implemented method comprising:
receiving, by a computer-based system for backflow prevention assembly testing, a keycode from an owner of a backflow prevention assembly;
transmitting, by the computer-based system, the keycode to a compliance management system; and
receiving, by the computer-based system and in response to the transmitting the keycode, information regarding the backflow prevention assembly.

2. The method of claim 1, further comprising placing, by the computer-based system, an order for a part to repair the backflow prevention assembly.

3. The method of claim 1, further comprising transmitting, by the computer-based system, arm invoice to the owner of the backflow prevention assembly.

4. The method of claim 1, wherein the keycode is generated by the compliance management system.

5. The method of claim 1, wherein the keycode is generated in response to a testing window opening for the backflow prevention assembly.

6. The method of claim 1, further comprising scanning, by the computer-based system, a code on the backflow prevention assembly.

7. The method of claim 6, wherein the code comprises a barcode.

8. The method of claim 1, further comprising transmitting, by the computer-based system, a geo-location of the computer-based system to the compliance management system.

9. A computer-implemented method comprising:
receiving, by a computer-based system for testing a backflow prevention assembly, a notification of an upcoming due date for the backflow prevention assembly;
storing, the computer-based system, backflow test data;
determining, by the computer-based system, a location of the computer-based system;
transmitting, by the computer-based system, the backflow test data, the location of the computer-based system, and a timestamp to at least one of a purveyor or an owner of the backflow prevention assembly.

10. The method of claim 9, further comprising scanning, by the computer-based system, a code on the backflow prevention assembly.

11. The method of claim 9, further comprising generating, by the computer-based system, a code, wherein the code is configured to be attached to the backflow prevention assembly.

12. The method of claim 10, wherein the code identifies the backflow prevention assembly.

13. The method of claim 9, wherein the backflow test data is entered in the computer-based system at a location of the backflow prevention assembly.

14. The method of claim 9, further comprising certifying, by the computer-based system, the backflow test data based on the location of the computer-based system, the timestamp, location of the backflow prevention assembly, and a signature of a tester.

15. A computer-implemented method comprising:
registering, by a computer-based system for managing backflow test data, a purveyor;
transmitting, by the computer-based system and to an owner of a backflow prevention assembly, a notification of an upcoming test date for the backflow prevention assembly;
receiving, by the computer-based system, backflow test data for the backflow prevention assembly;
receiving, by the computer-based system, a location of a testing device, a timestamp of the backflow test data, and a tester signature; and
certifying, by the computer-based system, the backflow test data based on the location of the testing device, the timestamp, and the tester signature.

16. The method of claim 15, further comprising transmitting, by the computer-based system, a notification of the backflow test data to at least one of the owner and the purveyor.

17. The method of claim 15, wherein the location of the testing device is determined using a GPS system.

18. The method of claim 15, further comprising generating, by the computer-based system, a barcode, wherein the barcode is configured to be placed on the backflow prevention assembly.

19. The method of claim 18, wherein the testing device scans the barcode on the backflow prevention assembly.

20. The method of claim 15, further comprising generating, by the computer-based system, a keycode corresponding to the upcoming test date.
